(19) United States
(12) Patent Application Publication
(10) Pub. No.: US 2026/0343561 A1
(43) Pub. Date: Oct. 29, 2026

(54) NON-TERRESTRIAL NETWORK FEEDBACK DISABLING VIA DOWNLINK CONTROL INFORMATION

(71) Applicant: LENOVO (BEIJING) LIMITED, Beijing (CN)

(72) Inventors: Zhi Yan, Beijing (CN); Hongmei Liu, Beijing (CN); Yuantao Zhang, Beijing (CN); Ruixiang Ma, Beijing (CN); Haiming Wang, Beijing (CN)

(21) Appl. No.: 19/113,538

(22) PCT Filed: Dec. 9, 2022
(86) PCT No.: PCT/CN2022/138055

§ 371 Date: Mar. 20, 2025

(51) Int. Cl. H04W 72/231; H04L 1/1829; H04L 5/00; H04W 84/06

(52) U.S. Cl. CPC H04W 72/231; H04L 1/1854; H04L 5/0053; H04W 84/06

(57) ABSTRACT

Methods and apparatuses for NTN feedback disabling via downlink control information are disclosed. A UE comprises a processor, and a transceiver coupled to the processor, wherein the processor is configured to cause the UE to: receive a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a modulation coding scheme (MCS) index, a resource associated with the HARQ feedback, a HARQ process number, a new data indicator (ND I), or any combination thereof; and receive the set of transport blocks based at least in part on the received control message.

### FIELD

The subject matter disclosed herein generally relates to wireless communications, and more particularly relates to methods and apparatuses for NTN (Non-Terrestrial Network) feedback disabling via downlink control information.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Non-Terrestrial Network (NTN), Internet of Things (IoT), machine-type communication (MTC), enhanced MTC (eMTC), Transport Block (TB), Physical Uplink Control Channel (PUCCH), Physical Uplink Shared Channel (PUSCH), acknowledgement (ACK), negative acknowledgement (NACK), Automatic Repeat request (ARQ), Hybrid Automatic Repeat request (HARQ), Physical Downlink Shared Channel (PDSCH), Narrow Band Internet of Things (NBIoT or NB-IoT), Downlink Control Information (DCI), modulation and coding scheme (MCS), Frequency Division Duplex (FDD), MTC PDCCH (MPDCCH), Physical Resource Block (PRB), enhanced control channel element (ECCE), coverage enhancement (CE), most significant bit (MSB), least significant bit (LSB).

For a downlink data transmission process, the data signals are transmitted in unit of transport block (TB). One TB is transmitted in one or more subframes with repetition. Afterwards, a feedback (ACK or NACK) of the data signals is transmitted in an uplink feedback channel (e.g., PUCCH or PUSCH) to indicate whether the corresponding data signals are correctly received (i.e., ACK) or not (i.e., NACK) at the UE side. Each downlink data transmission process is associated with a process number. The feedback of the data signal is associated with the process number so that the base unit (e.g., eNB) knows with which TB (or with which subframe) the feedback is associated. The process number may also be referred to as HARQ process number.

Disabling of the HARQ feedback has been supported in NR NTN. In particular, enabling and disabling of HARQ feedback for downlink transmission (e.g., PDSCH transmission) can be at least configurable per HARQ process via UE specific RRC signalling. For example, UE can be configured by RRC parameter to enable or disable the HARQ feedback per HARQ process (i.e., per HARQ process number) via bitmap manner. As shown in FIG. 1, suppose that there are 8 HARQ processes (e.g., with HARQ process numbers #0 to #7), a bitmap with 8 bits can indicate HARQ feedback enabling or disabling of the 8 HARQ processes. For example, 0 indicates HARQ feedback disabling and 1 indicates HARQ feedback enabling.

When HARQ feedback disabling is configured for an HARQ process number (or for an HARQ process), no explicit UL feedback for DL transmission acknowledges a successful transmission of a TB associated with an HARQ process having the HARQ process number. It means that the HARQ process number can be reused for a new DL transmission without waiting for the HARQ feedback. This can avoid HARQ stalling and consequently avoid throughput degradation. Correspondingly, retransmission at RLC layer (i.e., RLC ARQ) may be required to meet reliability requirements. Typically, ARQ re-transmissions in RLC layer can have high latency, which might be acceptable to IoT services (e.g., eMTC and NBIoT) since IoT services are generally delay tolerant.

In NR NTN, for ensuring the efficiency and reliability of transmission carrying some critical signaling, e.g., RRC configuration, at least one HARQ process with feedback enabling should be kept. For eMTC with limited HARQ processes, if the NR NTN HARQ feedback enabling or disabling per HARQ process configuration by RRC parameter is reused, it is hard to guarantee at least one HARQ process with feedback enabling, because RRC reconfiguration would cause large signaling overhead.

This invention targets solutions for NTN feedback disabling via downlink control information.

### BRIEF SUMMARY

Methods and apparatuses for NTN feedback disabling via downlink control information are disclosed.

In one embodiment, a UE comprises a processor; and a transceiver coupled to the processor, wherein the processor is configured to cause the UE to: receive a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a modulation coding scheme (MCS) index, a resource associated with the HARQ feedback, a HARQ process number, a new data indicator (NDI), or any combination thereof; and receive the set of transport blocks based at least in part on the received control message.

In some embodiment, the control message comprises a second field; the first field further indicates the MCS index or an MCS set; and the second field indicates the resource associated with the HARQ feedback, or a MCS sub-index within the MCS set, or any combination thereof.

In some embodiment, the control message further comprises a second field; and the first field further indicates the MCS index, or the HARQ process number and the NDI; and the second field indicates the resource associated with the HARQ feedback, the HARQ process number and the NDI or the MCS index.

In some embodiment, the first field includes multiple sub-fields, at least one of the multiple sub-fields indicates whether the HARQ feedback is enabled or disabled; the at least one sub-field is based at least in part on a quantity of transport blocks of the set of transport blocks.

In some embodiment, the resource associated with the HARQ feedback is based at least in part on the HARQ process number or a subframe number, or both.

In some embodiment, the processor is further configured to receive a radio resource control (RRC) message indicating whether the HARQ feedback is enabled or disabled; the HARQ feedback enabled or disabled associated with the set of transport blocks indicated by the first field overrides the HARQ feedback enabled or disabled indicated by the RRC message.

In some embodiment, the processor is further configured to receive a radio resource control (RRC) message indicating whether the HARQ feedback is enabled or disabled; the first field indicates whether HARQ feedback is enabled or disabled by indicating to override or to keep the HARQ feedback enabled or disabled indicated by the RRC message.

It means that to enable or disable the HARQ feedback based at least in part on the RRC message, the method comprises overriding an enabling or a disabling of the HARQ feedback, associated with the first field indicating whether the HARQ feedback is enabled or disabled for the set of transport blocks, based on the RRC message; or maintain the enabling or the disabling of the HARQ feedback associated with the first field indicating whether the HARQ feedback is enabled or disabled for the set of transport blocks.

In one embodiment, a method at a UE comprises receiving a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a modulation coding scheme (MCS) index, a resource associated with the HARQ feedback, a HARQ process number, a new data indicator (NDI), or any combination thereof; and receiving the set of transport blocks based at least in part on the received control message.

In another embodiment, a network entity comprises a processor; and a transceiver coupled to the processor, wherein the processor is configured to cause the network entity to: transmit a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a modulation coding scheme (MCS) index, a resource associated with the HARQ feedback, a HARQ process number, a new data indicator (NDI), or any combination thereof; and transmit the set of transport blocks based at least in part on the received control message.

In yet another embodiment, a method at a network entity (e.g., base unit) comprises transmitting a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a modulation coding scheme (MCS) index, a resource associated with the HARQ feedback, a HARQ process number, a new data indicator (NDI), or any combination thereof; and transmitting the set of transport blocks based at least in part on the received control message.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates NR NTN HARQ feedback disabling indication;

FIG. 2 illustrates the structure of the ‘Scheduling TBs for Unicast’ field;

FIG. 3 is a schematic flow chart diagram illustrating an embodiment of a method;

FIG. 4 is a schematic flow chart diagram illustrating another embodiment of a method; and

FIG. 5 is a schematic block diagram illustrating apparatuses according to one embodiment.

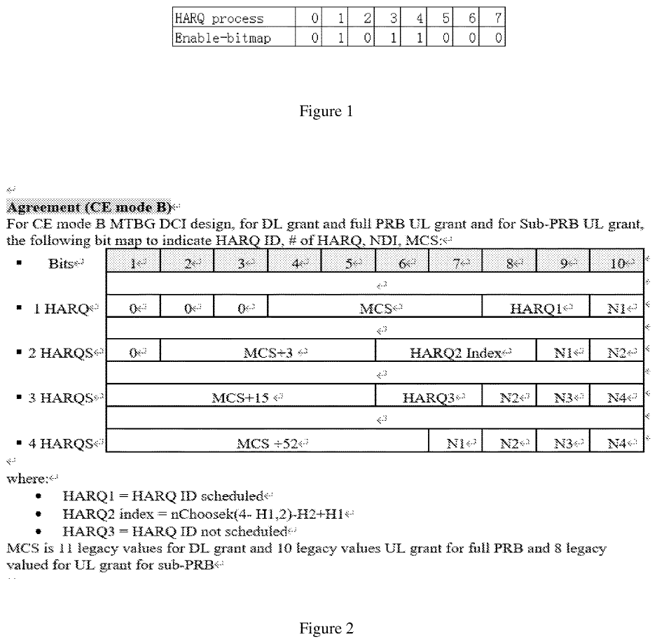

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

eMTC CE mode B supports 2 HARQ processes or 4 HARQ processes (if multiple TB scheduling is configured). It means that, for eMTC, a control message (e.g., a control signal, DCI format 6-1B) can schedule a set of transport blocks, the set of transport blocks can be one transport block for single transport block transmission or up to four (4) transport blocks for multiple transport blocks transmission, where each transport block is associated with a different HARQ process (i.e., a HARQ process with a different HARQ process number). Each HARQ process may be HARQ feedback enabling by default.

According to this disclosure, the control message (e.g., DCI format 6-1B) can indicate whether hybrid automatic repeat request (HARQ) feedback is enabled or disabled. The indication of whether HARQ feedback is enabled or disabled may apply to HARQ process associated with the single scheduled transport block or all HARQ process(es) associated with the set of transport blocks.

It is straightforward to add one field into the DCI format 6-1B to indicate whether hybrid automatic repeat request (HARQ) feedback is enabled or disabled. However, the added field is not favorable in consideration of added overhead.

In view of the above, this disclosure proposes several embodiments to indicate the HARQ feedback enabling or disabling associated with the scheduled transport blocks without adding a field to the scheduling DCI (e.g., DCI format 6-1B), nor adding any extra bit to the scheduling DCI.

Some related fields of DCI format 6-1B are shown in Table 1.

TABLE 1

| DCI format 6-1B field | Number of bits |
|---|---|
| modulation and coding scheme (MCS) | 4 |
| HARQ process number | 1 |
| new data indicator | 1 |
| HARQ-ACK resource offset | 2 |
| Scheduling TBs for Unicast | 10 |

The ‘MCS’ field of DCI format 6-1B has 4 bits, and indicates a MCS index. For eMTC, the candidate MCS indices indicated by the ‘MCS’ field can be from 0 to 9 (i.e., from ‘0000’ to ‘1001’). It means that there are six (6) unused states (e.g., from 10 to 15, i.e., from ‘1010’ to ‘1111’) for the ‘MCS’ field.

The ‘HARQ process number’ field indicates HARQ process number.

The ‘new data indicator’ field indicates new data indicator.

The ‘HARQ-ACK resource offset’ field indicates resource associated with the HARQ feedback (e.g., HARQ-ACK resource) for the set of transport blocks. If HARQ feedback disabling is indicated, it is unnecessary to indicate the HARQ-ACK resource for the set of transport blocks.

The ‘Scheduling TBs for Unicast’ field has 10 bits. The ‘Scheduling TBs for Unicast’ field is only present for multiple TB scheduling.

According to a first embodiment, the HARQ feedback enabling or disabling associated with the scheduled downlink transmission (i.e., scheduled TB(s)) is indicated by a first field (e.g., joint field) having 6 bits.

The joint field can be a new field to replace some existing (i.e., legacy) fields of DCI format 6-1B. For example, legacy ‘MCS’ field (having 4 bits) and legacy ‘HARQ-ACK resource offset’ field (having 2 bits) can be replaced by the joint field. It means that, when HARQ disabling feature is configured, the new field (i.e., the joint field) is present in DCI format 6-1B while the legacy ‘MCS’ field and the legacy ‘HARQ-ACK resource offset’ field are not present in DCI format 6-1B. Alternatively, the joint field can be composed by some existing fields of DCI format 6-1B. For example, the joint field is composed by the legacy ‘MCS’ field (with 4 bits) and legacy ‘HARQ-ACK resource offset’ field (with 2 bits). In particular, the legacy ‘MCS’ field may function as the four most significant bits of the joint field while the legacy ‘HARQ-ACK resource offset’ field function as the two least significant bits of the joint field.

According to the first embodiment, the joint field indicates the HARQ feedback enabling or disabling associated with the scheduled downlink transmission in addition to legacy indication(s). For example, if the joint field replaces the legacy ‘MCS’ field (with 4 bits) and the legacy ‘HARQ-ACK resource offset’ field (with 2 bits) (or alternatively, the legacy ‘MCS’ field (with 4 bits) and the legacy ‘HARQ-ACK resource offset’ field (with 2 bits) compose the joint field), the joint field indicates, in addition to the MCS index and the HARQ-ACK resource, the HARQ feedback enabling or disabling associated with the scheduled downlink transmission.

The legacy ‘HARQ-ACK resource offset’ field (with 2 bits) indicates the HARQ-ACK resource by 4 candidate values (e.g., ‘00’, ‘01’, ‘10’ and ‘11’).

The legacy ‘MCS’ field (with 4 bits) indicates the MCS index from 0 to 9 (i.e., from ‘0000’ to ‘1001’). Possible values 10 to 15 (i.e., from ‘1010’ to ‘1111’) of the ‘MCS’ field are unused states.

The joint field has 6 bits, which is equivalent to 64 states. 50 states are enough to indicate the HARQ feedback enabling or disabling associated with the scheduled downlink transmission, the MCS index and the HARQ-ACK resource. That is, 40 (=4*10) states are used for HARQ feedback enabling and indicate the MCS index and the HARQ-ACK resource; while 10 states are used for HARQ feedback disabling and indicate the MCS index. Incidentally, when HARQ feedback disabling is indicated, it is unnecessary to indicate the HARQ-ACK resource.

Table 2 illustrates an example of the joint field according to the first embodiment.

TABLE 2

| | HARQ | | |
|---|---|---|---|
| | feedback | | |
| Joint field | enabling | | HARQ-ACK |
| values | or disabling | MCS index | resource |
| 0~9 | Enabling | 0~9 (‘0000’ to ‘1001’) | ‘00’ |
| 10~19 | Enabling | 0~9 (‘0000’ to ‘1001’) | ‘01’ |
| 20~29 | Enabling | 0~9 (‘0000’ to ‘1001’) | ‘10’ |
| 30~39 | Enabling | 0~9 (‘0000’ to ‘1001’) | ‘11’ |
| 40~49 | Disabling | 0~9 (‘0000’ to ‘1001’) | X |

As shown in Table 2, if the joint field indicates 0 to 9, the HARQ feedback is indicated as enabling; the MCS index is from 0 to 9 (i.e., being equal to the joint field value), and the HARQ-ACK resource is indicated as ‘00’.

If the joint field indicates 10 to 19, the HARQ feedback is indicated as enabling; the MCS index is from 0 to 9 (i.e., being equal to the joint field value minus 10), and the HARQ-ACK resource is indicated as ‘01’.

If the joint field indicates 20 to 29, the HARQ feedback is indicated as enabling; the MCS index is from 0 to 9 (i.e., being equal to the joint field value minus 20), and the HARQ-ACK resource is indicated as ‘10’.

If the joint field indicates 30 to 39, the HARQ feedback is indicated as enabling; the MCS index is from 0 to 9 (i.e., being equal to the joint field value minus 30), and the HARQ-ACK resource is indicated as ‘11’.

If the joint field indicates 40 to 49, the HARQ feedback is indicated as disabling; the MCS index is from 0 to 9 (i.e., being equal to the joint field value minus 40), and the HARQ-ACK resource value is reserved (indicated as “X” in Table 2). It means that, when the HARQ feedback is disabled, it is unnecessary to indicate the HARQ-ACK resource.

It can be seen that, according to the first embodiment, UE receives a control message (e.g., DCI format 6-1B), the control message includes a joint field indicating at least the HARQ feedback enabling or disabling associated with the scheduled downlink transmission, where the HARQ feedback enabling or disabling is based on the value of the joint field.

In the example of Table 2, the joint field indicates, in addition to the HARQ feedback enabling or disabling associated with the scheduled downlink transmission, at least one of other indications (e.g., MCS index, and HARQ-ACK resource), while if the joint field values are from 0 to 39, HARQ feedback enabling is indicated; and if the joint field values are from 40 to 49, HARQ feedback disabling is indicated. In particular, values 0 to 39 of the joint field indicate three indications (i.e., HARQ feedback enabling or disabling associated with the scheduled downlink transmission, MCS index, and HARQ-ACK resource); while values 40 to 49 of the joint field indicate two indications (i.e., HARQ feedback enabling or disabling associated with the scheduled downlink transmission, and MCS index).

According to a second embodiment, UE receives a control message (e.g., DCI format 6-1B), the control message includes two (2) fields (e.g., a first field (e.g., a first joint field) and a second field (e.g., a second joint field)), where the first joint field indicates, in addition to the HARQ feedback enabling or disabling associated with the scheduled downlink transmission, MCS index or a MCS set index, and the second joint field indicates the HARQ-ACK resource or a MCS sub-index of the MCS set having the MCS set index.

An example of the second embodiment is shown in Table 3.

TABLE 3

| | HARQ feedback enabling: | HARQ feedback disabling: |
|---|---|---|
| | first joint field = ‘0000’ to | first joint field = ‘1010’ to |
| | ‘1001’ | ‘1100’ |
| first joint field, e.g., by | ‘0000’ to ‘1001’: MCS | ‘1010’ to ‘1100’: selecting |
| reusing legacy ‘MCS’ field | indication | a MCS set (1 out of 3) |
| (4 bits) | | |
| second joint field, e.g., by | HARQ-ACK resource | MCS sub-index within the |
| reusing legacy ‘HARQ- | indication | selected MCS set (1 out of |
| ACK resource offset’ field | | 4) |
| (2 bits) | | |

It can be seen from Table 3 that, if the first joint field (e.g., by reusing legacy ‘MCS’ field) indicates ‘0000’ to ‘1001’ (i.e., from 0 to 9), the first join field indicates HARQ feedback enabling of the HARQ process associated with the scheduled downlink transmission, and further indicates the MCS index. In this condition, the second joint field (e.g., legacy ‘HARQ-ACK resource offset’ field) indicates the HARQ-ACK resource.

If the first joint field (e.g., legacy ‘MCS’ field) indicates ‘1010 to ‘1100’ (i.e., from 10 to 12), the first joint field indicates HARQ feedback disabling of the HARQ process associated with the scheduled downlink transmission and further indicates a MCS set index (e.g., MCS set 0, MCS set 1 and MCS set 2) (i.e., selects a MCS set). In this condition, the second joint field (e.g., by reusing legacy ‘HARQ-ACK resource offset’ field) indicates a MCS sub-index within the selected MCS set (e.g., MCS sub-index 0, MCS sub-index 1, MCS sub-index 2, MCS sub-index 3). It means that the MCS index can be obtained by: MCS index=4*MCS set index+MCS sub-index. If HARQ feedback disabling is indicated, it is unnecessary to indicate the HARQ-ACK resource. The candidate MCS sets are three (3) and the candidate MCS sub-indices within each MCS set are four (4). It means that the total candidate MCS indices can be as many as 12 (=3*4), which is enough to cover the MCS index that is from 0 to 9. In particular, if the first joint field indicates ‘1010 to ‘1100’, the combination of the first joint field and the second joint field indicate the MCS index. For example, if the first joint field indicates ‘1011’ (i.e., MCS set index=1) and the second joint field indicates ‘01’ (i.e., MCS sub-index=1), MCS index=4*MCS set index+MCS sub-index=4*1+1=5.

According to a third embodiment, UE receives a control message (e.g., DCI format 6-1B), the control message includes two (2) fields (e.g., a first field (e.g., a first joint field) and a second field (e.g., a second joint field)), where the first joint field indicates, in addition to the HARQ feedback enabling or disabling associated with the scheduled downlink transmission, the MCS index, or the HARQ process number and new data indicator, and the second joint field indicates the HARQ-ACK resource, the HARQ process number and the new data indicator, or the MCS index. The third embodiment applies to eMTC CE Mode B with one TB scheduling.

An example of the third embodiment is shown in Table 4

TABLE 4

| | | HARQ feedback | HARQ feedback disabling: |
|---|---|---|---|
| | | enabling: first joint field = | first joint field = |
| | | ‘0000’ to ‘1001’ | ‘1010’ to ‘1101’ |
| first joint field, e.g., by reusing legacy | | ‘0000’ to ‘1001’: MCS | ‘1010’ to ‘1101’: HARQ |
| ‘MCS’ field (4 bits) | | index | process number and new |
| | | | data indicator (total 4 |
| | | | states of the first joint |
| | | | field) |
| Second joint | a sub-field by | HARQ-ACK resource | MCS index |
| field (4 bits) | reusing legacy | | |
| | ‘HARQ-ACK | | |
| | resource offset’ field | | |
| | (2 bits) | | |
| | a sub-field by | HARQ process number | |
| | reusing legacy | | |
| | ‘HARQ process | | |
| | number’ field (1 bit) | | |
| | a sub-field by | new data indicator | |
| | reusing legacy | | |
| | ‘NDI’ field (1 bit) | | |

It can be seen from Table 4 that, if the first joint field (e.g., by reusing legacy ‘MCS’ field) indicates ‘0000’ to ‘1001’ (i.e., from 0 to 9), the first joint field indicates HARQ feedback enabling associated with the scheduled downlink transmission, and further indicates the MCS index. In this condition, the second joint field (e.g., by reusing a combination of legacy ‘HARQ-ACK resource offset’ field, legacy ‘HARQ process number’ field and legacy ‘NDI’ field) indicates the HARQ-ACK resource, the HARQ process number and the new data indicator. It means that the second joint field can be regarded as being composed by 3 sub-fields (e.g., a sub-field by reusing legacy ‘HARQ-ACK resource offset’ field with 2 bits, a sub-field by reusing legacy ‘HARQ process number’ field with 1 bit, and a sub-field by reusing legacy ‘NDI’ field with 1 bit), where, the sub-field by reusing the legacy ‘HARQ-ACK resource offset’ field indicates the HARQ-ACK resource, the sub-field by reusing the legacy ‘HARQ process number’ field indicates the HARQ process number, and the sub-field by reusing the legacy ‘NDI’ field indicates the new data indicator.

If the first joint field (e.g., by reusing the legacy ‘MCS’ field) indicates ‘1010 to ‘1101’ (i.e., from 10 to 13), the first joint field indicates HARQ feedback disabling associated with the scheduled downlink transmission, and further indicates the HARQ process number and the new data indicator. It means that the four states ‘1010 to ‘1101’ are used to indicate the HARQ process number and the new data indicator. If HARQ feedback disabling is indicated, it is unnecessary to indicate the HARQ-ACK resource. The second joint field (e.g., by reusing a combination of the legacy ‘HARQ-ACK resource offset’ field, the legacy ‘HARQ process number’ field and the legacy ‘NDI’ field) (with a total of 4 bits) indicates the MCS index, e.g., from 0 to 9. For example, the legacy ‘HARQ process number’ field functions as the most significant bit (MSB) of the second joint field; the legacy ‘NDI’ field functions as the second bit of the second joint field; and the legacy ‘HARQ-ACK resource offset’ field functions as the two least significant bits (LSBs) of the second joint field.

A fourth embodiment relates to eMTC CE Mode B with multiple TB scheduling by DCI format 6-1B.

In multiple TB scheduling, the ‘Scheduling TBs for Unicast’ field is present in DCI format 6-1B. The ‘Scheduling TBs for Unicast’ field includes sub-fields of ‘MCS’, ‘HARQ’ (i.e., ‘HARQ1’, ‘HARQ2 Index’ and ‘HARQ3’) and ‘NDI’ (s) (i.e., ‘N1’, N2’, ‘N3’ and ‘N4’). FIG. 2 illustrates the structure of the ‘Scheduling TBs for Unicast’ field. It can be seen from FIG. 2 that the meaning of each of the ten (10) bits of the ‘Scheduling TBs for Unicast’ field is different for different numbers of the set of transport blocks (i.e., for different HARQs).

For one scheduled TB associated with one HARQ process (indicated as ‘1 HARQ’ in FIG. 2), bits 1, 2 and 3 are always ‘0’; bits 4, 5, 6 and 7 are ‘MCS’ sub-field indicating the MCS index (from 0 to 9, i.e., from ‘0000’ to ‘1001’); bits 8 and 9 (‘HARQ1’) indicate which one of the four HARQ processes is the one HARQ process; and bit 10 is the sub-field ‘NDI’ (i.e., ‘N1’) for the one HARQ process.

For two scheduled TBs associated with two HARQ processes (indicated as ‘2 HARQs’ in FIG. 2), bit 1 is always ‘0’; bits 2, 3, 4 and 5 are ‘MCS’ sub-field (‘MCS+3’ in FIG. 2) indicating the MCS index plus 3 (from 3 to 12, i.e., from ‘0011’ to ‘1100’); bits 6, 7 and 8 (‘HARQ2 Index’) indicate which two of the four HARQ processes are the two HARQ processes; and bits 9 and 10 are the sub-field ‘NDI's (e.g., bit 9 is the sub-field ‘NDI’, i.e., ‘N1’, for a first HARQ process of the two HARQ processes; and bit 10 is the sub-field ‘NDI’, i.e., ‘N2’, for a second HARQ process of the two HARQ processes).

For three scheduled TBs associated with three HARQ processes (indicated as ‘3 HARQs’ in FIG. 2), bits 1, 2, 3, 4 and 5 are ‘MCS’ sub-field (‘MCS+15’ in FIG. 2) indicating the MCS index plus 15 (from 15 to 24, i.e., from ‘01111’ to ‘11000’); bits 6 and 7 (‘HARQ3’) indicate which three of the four HARQ processes are the three HARQ processes; and bits 8, 9 and 10 are the sub-field ‘NDI’ (e.g., bit 8 is the sub-field ‘NDI’, i.e., ‘N1’, for a first HARQ process of the three HARQ processes; bit 9 is the sub-field ‘NDI’, i.e., ‘N2’, for a second HARQ process of the three HARQ processes; and bit 10 is the sub-field ‘NDI’, i.e., ‘N3’, for a third HARQ process of the three HARQ processes).

For four scheduled TBs associated with four HARQ processes (indicated as ‘4HARQs’ in FIG. 2), bits 1, 2, 3, 4, 5 and 6 are ‘MCS’ (‘MCS+52’ in FIG. 2) sub-field indicating the MCS index plus 52 (from 52 to 61, i.e., from ‘110100’ to ‘111101’); bits 7, 8, 9 and 10 are the sub-field ‘NDI’ (e.g., bit 7 is the sub-field ‘NDI’, i.e., ‘N1’, for a first HARQ process of the four HARQ processes; bit 8 is the sub-field ‘NDI’, i.e., ‘N2’, for a second HARQ process of the four HARQ processes; bit 9 is the sub-field ‘NDI’, i.e., ‘N3’, for a third HARQ process of the four HARQ processes; and bit 10 is the sub-field ‘NDI’, i.e., ‘N4’, for a fourth HARQ process of the four HARQ processes).

Accordingly, the structure of the sub-fields is determined by the number of scheduled TBs (from 1 to 4).

Table 5 illustrates detailed MCS sub-field values, i.e., MCS index=0 to 9 for each of 1 HARQ, 2 HARQs, 3 HARQs and 4 HARQs, in which some unused states are incorporated between 1 HARQ and 2 HARQs, between 2 HARQs and 3 HARQs, between 3 HARQs and 4 HARQs, and after 4 HARQs.

TABLE 5

| | MCS | | | | | | | | | | |
|---|---|---|---|---|---|---|---|---|---|---|---|
| | index | 1 | 2 | 3 | 4 | 5 | 6 | 7 | 8 | 9 | 10 |
| 1 HARQ | 0 | 0 | 0 | 0 | 0 | 0 | 0 | 0 | | | |
| | 1 | 0 | 0 | 0 | 0 | 0 | 0 | 1 | | | |
| | 2 | 0 | 0 | 0 | 0 | 0 | 1 | 0 | | | |
| | 3 | 0 | 0 | 0 | 0 | 0 | 1 | 1 | | | |
| | 4 | 0 | 0 | 0 | 0 | 1 | 0 | 0 | | | |
| | 5 | 0 | 0 | 0 | 0 | 1 | 0 | 1 | | | |
| | 6 | 0 | 0 | 0 | 0 | 1 | 1 | 0 | | | |
| | 7 | 0 | 0 | 0 | 0 | 1 | 1 | 1 | | | |
| | 8 | 0 | 0 | 0 | 1 | 0 | 0 | 0 | | | |
| | 9 | 0 | 0 | 0 | 1 | 0 | 0 | 1 | | | |
| | | 0 | 0 | 0 | 1 | 0 | 1 | 0 | | | |
| | | 0 | 0 | 0 | 1 | 0 | 1 | 1 | | | |
| 2 | 0 | 0 | 0 | 0 | 1 | 1 | | | | | |
| HARQs | 1 | 0 | 0 | 1 | 0 | 0 | | | | | |
| | 2 | 0 | 0 | 1 | 0 | 1 | | | | | |
| | 3 | 0 | 0 | 1 | 1 | 0 | | | | | |
| | 4 | 0 | 0 | 1 | 1 | 1 | | | | | |
| | 5 | 0 | 1 | 0 | 0 | 0 | | | | | |
| | 6 | 0 | 1 | 0 | 0 | 1 | | | | | |
| | 7 | 0 | 1 | 0 | 1 | 0 | | | | | |
| | 8 | 0 | 1 | 0 | 1 | 1 | | | | | |
| | 9 | 0 | 1 | 1 | 0 | 0 | | | | | |
| | | 0 | 1 | 1 | 0 | 1 | | | | | |
| | | 0 | 1 | 1 | 1 | 0 | | | | | |
| 3 | 0 | 0 | 1 | 1 | 1 | 1 | | | | | |
| HARQs | 1 | 1 | 0 | 0 | 0 | 0 | | | | | |
| | 2 | 1 | 0 | 0 | 0 | 1 | | | | | |
| | 3 | 1 | 0 | 0 | 1 | 0 | | | | | |
| | 4 | 1 | 0 | 0 | 1 | 1 | | | | | |
| | 5 | 1 | 0 | 1 | 0 | 0 | | | | | |
| | 6 | 1 | 0 | 1 | 0 | 1 | | | | | |
| | 7 | 1 | 0 | 1 | 1 | 0 | | | | | |
| | 8 | 1 | 0 | 1 | 1 | 1 | | | | | |
| | 9 | 1 | 1 | 0 | 0 | 0 | | | | | |
| | | 1 | 1 | 0 | 0 | 1 | | | | | |
| 4 | 0 | 1 | 1 | 0 | 1 | 0 | 0 | | | | |
| HARQs | 1 | 1 | 1 | 0 | 1 | 0 | 1 | | | | |
| | 2 | 1 | 1 | 0 | 1 | 1 | 0 | | | | |
| | 3 | 1 | 1 | 0 | 1 | 1 | 1 | | | | |
| | 4 | 1 | 1 | 1 | 0 | 0 | 0 | | | | |
| | 5 | 1 | 1 | 1 | 0 | 0 | 1 | | | | |
| | 6 | 1 | 1 | 1 | 0 | 1 | 0 | | | | |
| | 7 | 1 | 1 | 1 | 0 | 1 | 1 | | | | |
| | 8 | 1 | 1 | 1 | 1 | 0 | 0 | | | | |
| | 9 | 1 | 1 | 1 | 1 | 0 | 1 | | | | |
| | | 1 | 1 | 1 | 1 | 1 | 0 | | | | |
| | | 1 | 1 | 1 | 1 | 1 | 1 | | | | |

It can be seen from Table 5 that ‘0001010’ and ‘0001011’ (for bits 1 to 7) are two unused states between 1 HARQ and 2 HARQs. So, these two unused states can be used for indicating HARQ feedback disabling associated with the scheduled downlink transmission (i.e., associated with the one scheduled TB). In addition, a combination of these unused states (2 states) and the ‘HARQ-ACK resource offset’ field (with 2 bits) (which is unnecessary to indicate the HARQ-ACK resource for the HARQ feedback disabled) can indicate the first or the last 8 (i.e., 2 unused states+2 bits=8 states) MCS indices (i.e., MCS index=0 to 7 or MCS index=2 to 9) along with the HARQ feedback disabling. Whether the combination of these unused states (2 states) and the legacy ‘HARQ-ACK resource offset’ field (with 2 bits) indicates one MCS index from the first 8 MCS indices or from the last 8 MCS indices may depend on HARQ process number or subframe number. For example, if HARQ process number is 0 or 1, the combination of these unused states (2 states) and the legacy ‘HARQ-ACK resource offset’ field (with 2 bits) may indicate one MCS index from the first 8 MCS indices (i.e., MCS index=0 to 7); while if HARQ process number is other numbers than 0 and 1, the combination of these unused states (2 states) and the ‘HARQ-ACK resource offset’ field (with 2 bits) may indicate one MCS index from the last 8 MCS indices (i.e., MCS index=2 to 9).

As a whole, when the bits 1 to 7 of the ‘Scheduling TBs for Unicast’ field are from ‘0000000’ to ‘0001011’, one TB is scheduled. If the bits 1 to 7 are from ‘0000000’ to ‘0001001’, HARQ feedback enabling is indicated and bits 4 to 7 further indicate the MCS index, and if the bits 1 to 7 are from ‘0001010’ to ‘0001011’, HARQ feedback disabling is indicated while the MCS index is indicated by the combination of ‘0001010’ or ‘0001011’ (for bits 1 to 7) and the ‘HARQ-ACK resource offset’ field.

For two scheduled TBs, three bits (i.e., bits 6, 7 and 8) (‘HARQ Index2’) indicate which two of the four HARQ processes are associated with the two scheduled TBs. Since only 6 states of the three bits (e.g., from ‘000’ to ‘101’) are enough to indicate which two of the four HARQ processes are associated with the two scheduled TBs, there are two (2) unused states (e.g., ‘110’ and ‘111’) in the ‘HARQ2 Index’ sub-field. So, these two unused states of ‘HARQ2 Index’ sub-field can be used for indicating HARQ feedback disabling associated with the scheduled downlink transmission (i.e., associated with the two scheduled TBs). In addition, a combination of these unused states (2 states) of the ‘HARQ2 Index’ sub-field and the ‘HARQ-ACK resource offset’ field (with 2 bits) (which is unnecessary to indicate the HARQ-ACK resource for the HARQ feedback disabled) can indicate which two of the four HARQ processes are associated with the two scheduled TBs, along with the HARQ feedback disabling. In particular, the two unused states and the two bits of the ‘HARQ-ACK resource offset’ field can provide 8 states that are enough to indicate 6 candidate values to indicate which two of the four HARQ processes are associated with the two scheduled TBs.

As a whole, when bits 1 to 5 of the ‘Scheduling TBs for Unicast’ field are from ‘00011’ to ‘01100’, if the bits 6 to 8 of the ‘Scheduling TBs for Unicast’ field are from ‘000’ to ‘101’, HARQ feedback enabling is indicated and the bits 6 to 8 further indicate which two of the four HARQ processes are associated with the two scheduled TBs, and if the bits 6 to 8 of the ‘Scheduling TBs for Unicast’ field are from ‘110’ to ‘111’, HARQ feedback disabling is indicated while which two of the four HARQ processes are associated with the two scheduled TBs is indicated by the combination of ‘110’ or ‘111’ (for bits 6 to 8) and the ‘HARQ-ACK resource offset’ field.

It can be seen from Table 5 that ‘01101’ and ‘01110’ (for bits 1 to 5) are unused states between 2 HARQs and 3 HARQs, while ‘11001’ (for bits 1 to 5) is unused state between 3 HARQs and 4 HARQs. So, two of the three unused states (e.g., ‘01110’ and 11001’) can be used for indicating HARQ feedback disabling associated with the scheduled down transmission (i.e., associated with the three scheduled TBs). In addition, a combination of the two unused states and the ‘HARQ-ACK resource offset’ field (with 2 bits) (which is unnecessary to indicate the HARQ-ACK resource for the HARQ feedback disabled) can indicate the first or the last 8 (i.e., 2 unused states+2 bits=8 states) MCS indices (i.e., MCS index=0 to 7 or MCS index=2 to 9) along with the HARQ feedback disabling. Whether the combination of these unused states (2 states) and the ‘HARQ-ACK resource offset’ field (with 2 bits) indicates one MCS index from the first 8 MCS indices or from the last 8 MCS indices may depend on HARQ process number or subframe number.

As a whole, when the bits 1 to 5 of the ‘Scheduling TBs for Unicast’ field are from ‘01110’ to ‘11001’, three TBs are scheduled. If the bits 1 to 5 are from ‘01111’ to ‘11000’, HARQ feedback enabling is indicated and bits 1 to 5 further indicate the MCS index plus 15, and if the bits 1 to 5 are ‘01110’ or ‘11001’, HARQ feedback disabling is indicated while the MCS index is indicated by the combination of ‘01110 or ‘11001’ (for bits 1 to 5) and the ‘HARQ-ACK resource offset’ field.

It can be seen from Table 5 that ‘111110 and ‘111111’ (for bits 1 to 6) are two unused states after 4 HARQs. So, these two unused states can be used for indicating HARQ feedback disabling associated with the scheduled down transmission (i.e., associated with the four scheduled TBs). In addition, a combination of these unused states (2 states) and the ‘HARQ-ACK resource offset’ field (with 2 bits) (which is unnecessary to indicate the HARQ-ACK resource for the HARQ feedback disabled) can indicate the first or the last 8 (i.e., 2 unused states+2 bits=8 states) MCS indices (i.e., MCS index=0 to 7 or MCS index=2 to 9) along with the HARQ feedback disabling. Whether the combination of these unused states (2 states) and the ‘HARQ-ACK resource offset’ field (with 2 bits) indicates one MCS index from the first 8 MCS indices or from the last 8 MCS indices may depend on HARQ process number or subframe number.

As a whole, when the bits 1 to 6 of the ‘Scheduling TBs for Unicast’ field are from ‘110100 to ‘111111’, four TBs are scheduled. If the bits 1 to 6 are from ‘110100’ to ‘111101’, HARQ feedback enabling is indicated and bits 1 to 6 further indicate the MCS index plus 52, and if the bits 1 to 6 are from ‘111110’ to ‘111111’, HARQ feedback disabling is indicated while the MCS index is indicated by the combination of ‘111110’ or ‘111111’ (for bits 1 to 6) and the ‘HARQ-ACK resource offset’ field.

Incidentally, the unused states in the ‘Scheduling TBs for Unicast’ field can be referred to as flag of the ‘Scheduling TBs for Unicast’ field to indicate the HARQ feedback disabling for a particular transmission.

A fifth embodiment relates to a scenario of FDD and one configured serving cell. The UE uses a PUCCH resource for transmission of the HARQ-ACK feedback, where the PUCCH resource is determined by for example

$${n}_{PUCCH}^{( l , {p}_{0} )} = {n}_{ECCE , q} + {Δ}_{ARO} + {N}_{PUCCH , q}^{( ml )}$$

if MPDCCH-PRB-set is configured for distributed transmission.

Δ_{ARO} is determined from the ‘HARQ-ACK resource offset’ field in the DCI format of the corresponding MPDCCH as shown in Table 6.

TABLE 6

| ‘HARQ-ACK resource offset’ field value | Δ_{ARO} |
|---|---|
| 0 | 0 |
| 1 | −1 |
| 2 | −2 |
| 3 | 2 |

n_{ECCE,q} is the number of the first ECCE (i.e., lowest ECCE index used to construct the MPDCCH) in the last detected MPDCCH used for transmission of the corresponding DCI assignment in MPDCCH-PRB-set.

$${N}_{P UCCH , q}^{( ml )}$$

for MPDCCH-PRB-set is configured by the higher layer parameter.

In eMTC CE Mode B, it has been proposed to use one state of ‘HARQ-ACK resource offset’ field in DCI format 6-1B to indicate the HARQ feedback disabling. If a predetermined one state is used, scheduling restriction will be made to some PUCCH resource(s).

In view of the above, according to the fifth embodiment, the (one) state of the ‘HARQ-ACK resource offset’ field to indicate the HARQ feedback disabling is determined by HARQ process number and/or subframe number.

For a first example, for HARQ processes 0 and 1, the state (or value) of the ‘HARQ-ACK resource offset’ field to indicate the HARQ feedback disabling is 0, and for HARQ processes 2 and 3, the state (or value) of the ‘HARQ-ACK resource offset’ field to indicate the HARQ feedback disabling is 1.

For a second example, the one state of the ‘HARQ-ACK resource offset’ field to indicate the HARQ feedback disabling is subframe number % 4.

For a third example, the HARQ process number and subframe number % 4 are further added to the equation to determine the PUCCH resource.

According to a sixth embodiment, UE is configured with an RRC message (e.g., HARQ feedback enabling/disabling message) with bitmap manner, where the RRC message indicates the HARQ feedback enabling or disabling for each HARQ process, and the UE further receives a control message that indicates to override or to keep the HARQ feedback enabling or disabling indicated by the RRC message for the downlink transmission scheduled by the control message.

The control message can be the control message according to any of the first embodiment, the second embodiment, the third embodiment, the fourth embodiment and the fifth embodiment.

A first example of the sixth embodiment is shown in Table 7 by taking the control message according to the second embodiment as the control message indicating to override or to keep the HARQ feedback enabling or disabling indicated by the RRC message.

TABLE 7

| | Configured as HARQ feedback | Configured as HARQ feedback |
|---|---|---|
| | enabling by HARQ feedback | disabling by HARQ feedback |
| | enabling/disabling message | enabling/disabling message |
| first field, e.g., | Keep RRC configuration: | Keep RRC configuration: |
| ‘MCS’ field (4 | the values ranging from ‘0000’ to | the values ranging from ‘1010’ |
| bits) | ‘1001’ indicate HARQ feedback | to ‘1100’ indicating HARQ |
| | enabling and MCS | feedback disabling and MCS set |
| | | (1 out of 3) |
| | Override the RRC configuration | Override the RRC configuration |
| | for the scheduled downlink | for the scheduled downlink |
| | transmission: | transmission: |
| | the values ranging from ‘1010’ to | the values ranging from ‘0000’ |
| | ‘1100’ indicate HARQ feedback | to ‘1001’ indicate HARQ |
| | disabling and MCS set (1 out of 3) | feedback enabling and MCS |
| second field, e.g., | Keep RRC configuration: | Keep RRC configuration: |
| ‘HARQ-ACK | HARQ-ACK resource indication | the values indicate MCS within |
| resource offset’ | | the selected MCS set |
| field (2 bits) | Override the RRC configuration | Override the RRC configuration |
| | for the scheduled downlink | for the scheduled downlink |
| | transmission: | transmission: |
| | the values indicate MCS within | HARQ-ACK resource |
| | the selected MCS set | indication |

If the HARQ feedback enabling/disabling message indicates HARQ feedback enabling, the first field indicates a value ranging from 0 to 9 to keep the RRC configuration (i.e., keeping the HARQ feedback enabling indicated by the HARQ feedback enabling/disabling message for the scheduled downlink transmission), or indicates a value ranging from ‘1010’ to ‘1100’ to override the RRC configuration (i.e., overriding the HARQ feedback enabling indicated by the HARQ feedback enabling/disabling message as HARQ feedback disabling associated with the scheduled downlink transmission).

If the HARQ feedback enabling/disabling message indicates HARQ feedback disabling, the first field indicates a value ranging from ‘1010’ to ‘1100’ to keep the RRC configuration (i.e., keeping the HARQ feedback disabling indicated by the HARQ feedback enabling/disabling message for the scheduled downlink transmission), or indicates a value ranging from 0 to 9 to override the RRC configuration (i.e., overriding the HARQ feedback disabling indicated by the HARQ feedback enabling/disabling message as HARQ feedback enabling associated with the scheduled downlink transmission).

The sixth embodiment also applies to NTN NB-IoT HARQ feedback disabling and enabling with DCI indication.

For NB-IoT, the HARQ feedback enabling or disabling associated with the scheduled downlink transmission shall be indicated in DCI format N1. Some related fields of DCI format N1 are shown in Table 8

TABLE 8

| DCI format N1 field | Number of bits |
|---|---|
| Modulation and coding scheme (MCS) | 4 |
| HARQ-ACK resource | 4 |

The ‘MCS’ field of DCI format N1 has 4 bits. The ‘MCS’ field of DCI format N1 indicates a MCS index. For NB-IoT, the candidate MCS indices indicated by the ‘MCS’ field can be from 0 to 13 (i.e., from ‘0000’ to ‘1101’). It means that there are six (2) unused states (e.g., from 14 to 15, i.e., from ‘1110’ to ‘1111’) for the ‘MCS’ field.

The ‘HARQ-ACK resource offset’ field of DCI format N1 has 4 bits, and indicates HARQ-ACK resource. If HARQ feedback disabling is indicated, it is unnecessary to indicate the HARQ-ACK resource for the scheduled downlink transmission.

In view of the above, the HARQ feedback enabling or disabling associated with the scheduled downlink transmission can be indicated as shown in Table 9.

TABLE 9

| DCI format N1 field | HARQ feedback enabling | HARQ feedback disabling |
|---|---|---|
| Modulation and coding | The values ranging from ‘0000’ to | The value ‘1110’ indicates |
| scheme (MCS): 4 bits | ‘1101’ indicate HARQ feedback | HARQ feedback disabling |
| | enabling, and indicate the MCS | |
| | index | |
| HARQ-ACK resource: 4 | The values ranging from ‘0000’ to | The values ranging from |
| bits | ‘1111’ indicate the HARQ-ACK | ‘0000’ to ‘1101’ indicate the |
| | feedback resource | MCS index |

As shown in Table 9, when the ‘MCS’ field indicates any of values ranging from ‘0000’ to ‘1101’, HARQ feedback enabling associated with the scheduled downlink transmission is indicated. Any of the values ranging from ‘0000’ to ‘1101’ of the ‘MCS’ field also indicates the MCS index. When the ‘MCS’ field indicates any of values ranging from ‘0000’ to ‘1101’, the ‘HARQ-ACK resource’ field (which has 4 bits) indicates a value ranging from ‘0000’ to ‘1111’, which indicates the HARQ-ACK feedback resource information.

When the ‘MCS’ field indicates value ‘1110’, HARQ feedback disabling associated with the scheduled downlink transmission is indicated. In this condition, the ‘MCS’ field functions as HARQ feedback disabling indicator. Since HARQ feedback disabling associated with the scheduled downlink transmission is indicated, it is unnecessary to indicate the HARQ-ACK feedback resource information. So, the ‘HARQ-ACK resource’ field can be reused to indicate the MCS index. As shown in Table 9, when the ‘MCS’ field indicates the value ‘1110’, the ‘HARQ-ACK resource’ field indicates a value of any of ‘0000’ to ‘1101’ functioning as the MCS index.

A second example of the sixth embodiment is shown in Table 10 by taking the control message shown in Table 9 as the control message indicating to override or to keep the HARQ feedback enabling or disabling indicated by the RRC message.

TABLE 10

| | Configured as HARQ feedback | Configured as HARQ feedback |
|---|---|---|
| | enabling by HARQ feedback | disabling by HARQ feedback |
| | enabling/disabling message | enabling/disabling message |
| Modulation and | Keep RRC configuration: | Keep RRC configuration: |
| coding scheme | the values ranging from ‘0000’ to | the value ‘1110’ indicate HARQ |
| (MCS): 4 bits | ‘1101’ indicate HARQ feedback | feedback disabling |
| | enabling and MCS | |
| | Override the RRC configuration | Override the RRC configuration |
| | for the scheduled downlink | for the scheduled downlink |
| | transmission: | transmission: |
| | the value ‘1110’ indicate HARQ | the values ranging from ‘0000’ |
| | feedback disabling | to ‘1101’ indicate HARQ |
| | | feedback enabling and MCS |
| HARQ-ACK | Keep RRC configuration: | Keep RRC configuration: |
| resource: 4 bits | The values ranging from ‘0000’ to | The values ranging from ‘0000’ |
| | ‘1111’ indicate HARQ-ACK | to ‘1101’ indicate the MCS |
| | resource | index |
| | Override RRC default | Override the RRC configuration |
| | configuration for the scheduled | for the scheduled downlink |
| | downlink transmission: | transmission: |
| | The values ranging from ‘0000’ to | The values ranging from ‘0000’ |
| | ‘1101’ indicate the MCS index | to ‘1111’ indicate HARQ-ACK |
| | | resource |

If the HARQ feedback enabling/disabling message indicates HARQ feedback enabling, the ‘MCS’ field indicates a value ranging from ‘0000’ to ‘1101’ to keep the RRC configuration (i.e., keeping the HARQ feedback enabling indicated by the HARQ feedback enabling/disabling message for the scheduled downlink transmission), or indicates a value ‘1110’ to override the RRC configuration (i.e., overriding the HARQ feedback enabling indicated by the HARQ feedback enabling/disabling message as HARQ feedback disabling associated with the scheduled downlink transmission).

If the HARQ feedback enabling/disabling message indicates HARQ feedback disabling, the ‘MCS’ field indicates a value ‘1110’ to keep the RRC configuration (i.e., keeping the HARQ feedback disabling indicated by the HARQ feedback enabling/disabling message for the scheduled downlink transmission), or indicates a value ranging from ‘0000’ to ‘1101’ to override the RRC configuration (i.e., overriding the HARQ feedback disabling indicated by the HARQ feedback enabling/disabling message as HARQ feedback enabling associated with the scheduled downlink transmission).

Incidentally, the above-described fifth embodiment also applies to NTN NB-IoT HARQ feedback disabling and enabling with DCI indication. A fourth example of the fifth embodiment is described as follows: the ‘HARQ-ACK resource’ field has 4 bits, corresponding to states 0 to 15, where the state 15 can be used for HARQ feedback disabling indication for HARQ process 0 while the state 7 can be used for HARQ feedback disabling indication for HARQ process 1.

In the above-described sixth embodiment, the control message indicates to override or to keep the HARQ feedback enabling or disabling indicated by the RRC message. According to a variety of the sixth embodiment, the control message indicates the HARQ feedback enabling or disabling associated with the scheduled TB(s) by the control message, where the HARQ feedback enabling or disabling indicated by the control message overrides HARQ feedback enabling or disabling indicated by the RRC message. It means that if the control message indicates the HARQ feedback enabling or disabling, the HARQ feedback enabling or disabling indicated by the RRC message is not considered.

If only one TB is scheduled, the sixth embodiment and the variety of the sixth embodiment can indicate the HARQ feedback enabling or disabling associated with the scheduled one TB with the same result. For example, suppose the scheduled one TB by the control message is associated with HARQ process 0, and HARQ process 0 is indicated as HARQ feedback disabling by the RRC message, the control message according to the sixth embodiment may keep the RRC configuration (i.e., resulting HARQ feedback disabling associated with the scheduled one TB) or override the RRC configuration (i.e., resulting HARQ feedback enabling associated with the scheduled one TB), while the control message according to the variety of the sixth embodiment may indicate HARQ feedback disabling associated with the scheduled one TB (i.e., resulting HARQ feedback disabling associated with the scheduled one TB) or indicate HARQ feedback enabling associated with the scheduled one TB (i.e., resulting HARQ feedback enabling associated with the scheduled one TB).

On the other hand, if multiple TBs (e.g., two TBs: a first TB associated with one HARQ process (e.g., HARQ process 0) and a second TB associated with another HARQ process (e.g., HARQ process 1)) are scheduled, and the two HARQ processes (e.g., HARQ process 0 and HARQ process 1) are indicated by the RRC message as different HARQ feedbacks (e.g., HARQ process 0 with HARQ feedback enabling, and HARQ process 1 with HARQ feedback disabling), the sixth embodiment and the variety of the sixth embodiment will indicate the HARQ feedback enabling or disabling associated with the scheduled two TBs with the different results. In particular, the control message according to the sixth embodiment may keep the RRC configuration (i.e., resulting HARQ feedback enabling associated with the scheduled first TB, and HARQ feedback disabling associated with the scheduled second TB) or override the RRC configuration (i.e., resulting HARQ feedback disabling associated with the scheduled first TB, and HARQ feedback enabling associated with the scheduled second TB), while the control message according to the variety of the sixth embodiment may indicate HARQ feedback enabling associated with the scheduled TBs (i.e., resulting HARQ feedback enabling associated with both the scheduled first TB and the scheduled second TB) or indicate HARQ feedback disabling associated with the scheduled TBs (i.e., resulting HARQ feedback disabling associated with both the scheduled first TB and the scheduled second TB).

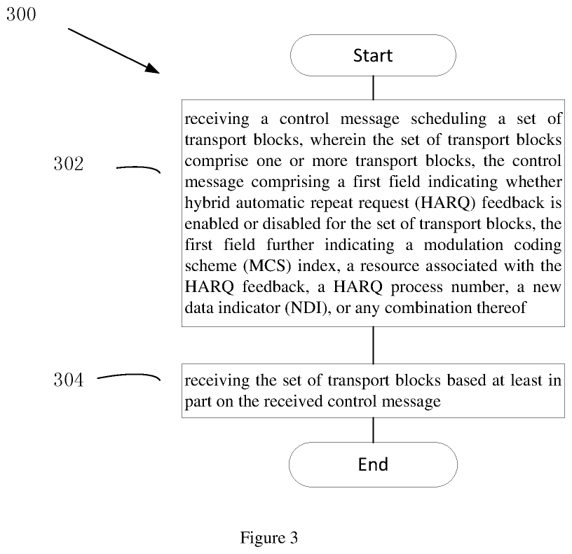

FIG. 3 is a schematic flow chart diagram illustrating an embodiment of a method 300 according to the present application. In some embodiments, the method 300 is performed by an apparatus, such as a remote unit (UE). In certain embodiments, the method 300 may be performed by a processor executing program code, for example, a microcontroller, a microprocessor, a CPU, a GPU, an auxiliary processing unit, a FPGA, or the like.

The method 300 may comprise 302 receiving a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a modulation coding scheme (MCS) index, a resource associated with the HARQ feedback, a HARQ process number, a new data indicator (NDI), or any combination thereof; and 304 receiving the set of transport blocks based at least in part on the received control message.

In some embodiment, the control message comprises a second field; the first field further indicates the MCS index or an MCS set; and the second field indicates the resource associated with the HARQ feedback, or a MCS sub-index within the MCS set, or any combination thereof.

In some embodiment, the control message further comprises a second field; and the first field further indicates the MCS index, or the HARQ process number and the NDI; and the second field indicates the resource associated with the HARQ feedback, the HARQ process number and the NDI or the MCS index.

In some embodiment, the first field includes multiple sub-fields, at least one of the multiple sub-fields indicates whether the HARQ feedback is enabled or disabled; the at least one sub-field is based at least in part on a quantity of transport blocks of the set of transport blocks.

In some embodiment, the resource associated with the HARQ feedback is based at least in part on the HARQ process number or a subframe number, or both.

In some embodiment, the method further comprises receiving a radio resource control (RRC) message indicating whether the HARQ feedback is enabled or disabled; the HARQ feedback enabled or disabled associated with the set of transport blocks indicated by the first field overrides the HARQ feedback enabled or disabled indicated by the RRC message.

In some embodiment, the method further comprises receiving a radio resource control (RRC) message indicating whether the HARQ feedback is enabled or disabled; the first field indicates whether HARQ feedback is enabled or disabled by indicating to override or to keep the HARQ feedback enabled or disabled indicated by the RRC message.

It means that to enable or disable the HARQ feedback based at least in part on the RRC message, the method comprises overriding an enabling or a disabling of the HARQ feedback, associated with the first field indicating whether the HARQ feedback is enabled or disabled for the set of transport blocks, based on the RRC message; or maintain the enabling or the disabling of the HARQ feedback associated with the first field indicating whether the HARQ feedback is enabled or disabled for the set of transport blocks.

In some examples, a UE may determine to keep the HARQ feedback disabled or enabled as indicated in the first field received in the control message. In these examples, the UE may ignore the indication received in the RRC message. Put another way, the UE may refrain from changing the HARQ feedback from enabled (as indicated in the first field of the received control message) to disabled (as indicated in the received RRC message). Alternatively, the UE may refrain from changing the HARQ feedback from disabled (as indicated in the first field of the received control message) to enabled (as indicated in the received RRC message).

Additionally or alternatively, the UE may change (e.g., override, update, modify) the HARQ feedback from disabled to enabled, or from enabled to disabled, based on the RRC message. In some examples, the UE may switch, based on the RRC message, the HARQ feedback from disabled to enabled. In some other examples, the UE may switch, based on the RRC message, the HARQ feedback from disabled to enabled. Put another way, the UE may change (e.g., override) the HARQ feedback to be enabled or disabled, which may be different from the indication, received in the control message, via the first field that that HARQ feedback is enabled or disabled.

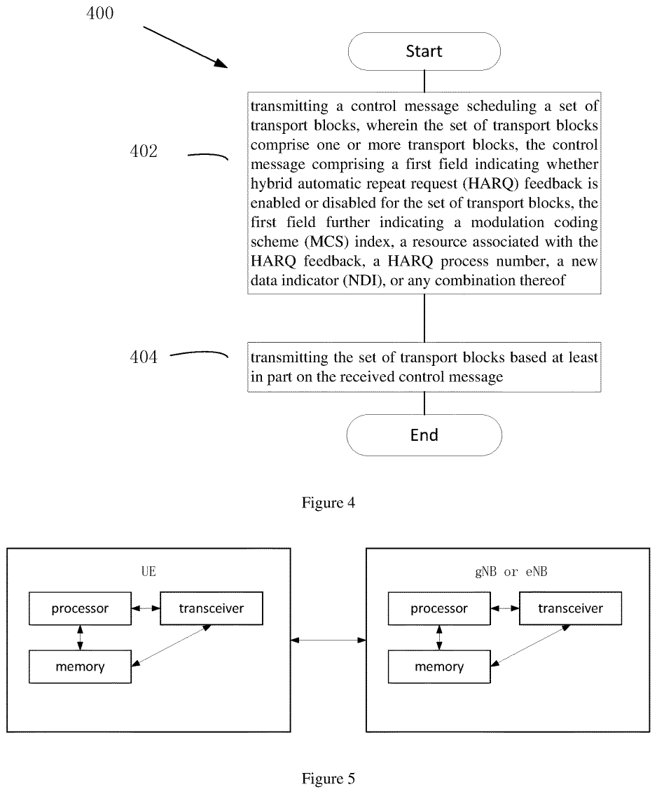

FIG. 4 is a schematic flow chart diagram illustrating a further embodiment of a method 400 according to the present application. In some embodiments, the method 400 is performed by an apparatus, such as a network entity (e.g., a base unit). In certain embodiments, the method 400 may be performed by a processor executing program code, for example, a microcontroller, a microprocessor, a CPU, a GPU, an auxiliary processing unit, a FPGA, or the like.

The method 400 may comprise 402 transmitting a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a modulation coding scheme (MCS) index, a resource associated with the HARQ feedback, a HARQ process number, a new data indicator (NDI), or any combination thereof; and 404 transmitting the set of transport blocks based at least in part on the received control message.

In some embodiment, the control message comprises a second field; the first field further indicates the MCS index or an MCS set; and the second field indicates the resource associated with the HARQ feedback, or a MCS sub-index within the MCS set, or any combination thereof.

In some embodiment, the control message further comprises a second field; and the first field further indicates the MCS index, or the HARQ process number and the NDI; and the second field indicates the resource associated with the HARQ feedback, the HARQ process number and the NDI or the MCS index.

In some embodiment, the first field includes multiple sub-fields, at least one of the multiple sub-fields indicates whether the HARQ feedback is enabled or disabled; the at least one sub-field is based at least in part on a quantity of transport blocks of the set of transport blocks.

In some embodiment, the resource associated with the HARQ feedback is based at least in part on the HARQ process number or a subframe number, or both.

In some embodiment, the method further comprises transmitting a radio resource control (RRC) message indicating whether the HARQ feedback is enabled or disabled; the HARQ feedback enabled or disabled associated with the set of transport blocks indicated by the first field overrides the HARQ feedback enabled or disabled indicated by the RRC message.

In some embodiment, the method further comprises transmitting a radio resource control (RRC) message indicating whether the HARQ feedback is enabled or disabled; the first field indicates whether HARQ feedback is enabled or disabled by indicating to override or to keep the HARQ feedback enabled or disabled indicated by the RRC message.

It means that to enable or disable the HARQ feedback based at least in part on the RRC message, the method comprises overriding an enabling or a disabling of the HARQ feedback, associated with the first field indicating whether the HARQ feedback is enabled or disabled for the set of transport blocks, based on the RRC message; or maintain the enabling or the disabling of the HARQ feedback associated with the first field indicating whether the HARQ feedback is enabled or disabled for the set of transport blocks.

FIG. 5 is a schematic block diagram illustrating apparatuses according to one embodiment.

Referring to FIG. 5, the UE (i.e., the remote unit) includes a processor, a memory, and a transceiver. The processor implements a function, a process, and/or a method which are proposed in FIG. 3.

The UE comprises a processor; and a transceiver coupled to the processor, wherein the processor is configured to cause the UE to: receive a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a modulation coding scheme (MCS) index, a resource associated with the HARQ feedback, a HARQ process number, a new data indicator (NDI), or any combination thereof; and receive the set of transport blocks based at least in part on the received control message.

In some embodiment, the control message comprises a second field; the first field further indicates the MCS index or an MCS set; and the second field indicates the resource associated with the HARQ feedback, or a MCS sub-index within the MCS set, or any combination thereof.

In some embodiment, the control message further comprises a second field; and the first field further indicates the MCS index, or the HARQ process number and the NDI; and the second field indicates the resource associated with the HARQ feedback, the HARQ process number and the NDI or the MCS index.

In some embodiment, the first field includes multiple sub-fields, at least one of the multiple sub-fields indicates whether the HARQ feedback is enabled or disabled; the at least one sub-field is based at least in part on a quantity of transport blocks of the set of transport blocks.

In some embodiment, the resource associated with the HARQ feedback is based at least in part on the HARQ process number or a subframe number, or both.

In some embodiment, the processor is further configured to receive a radio resource control (RRC) message indicating whether the HARQ feedback is enabled or disabled; the HARQ feedback enabled or disabled associated with the set of transport blocks indicated by the first field overrides the HARQ feedback enabled or disabled indicated by the RRC message.

In some embodiment, the processor is further configured to receive a radio resource control (RRC) message indicating whether the HARQ feedback is enabled or disabled; the first field indicates whether HARQ feedback is enabled or disabled by indicating to override or to keep the HARQ feedback enabled or disabled indicated by the RRC message.

It means that to enable or disable the HARQ feedback based at least in part on the RRC message, the method comprises overriding an enabling or a disabling of the HARQ feedback, associated with the first field indicating whether the HARQ feedback is enabled or disabled for the set of transport blocks, based on the RRC message; or maintain the enabling or the disabling of the HARQ feedback associated with the first field indicating whether the HARQ feedback is enabled or disabled for the set of transport blocks.

Referring to FIG. 5, the gNB (i.e., network entity, e.g., base unit) includes a processor, a memory, and a transceiver. The processors implement a function, a process, and/or a method which are proposed in FIG. 4.

The network entity comprises a processor; and a transceiver coupled to the processor, wherein the processor is configured to cause the network entity to: transmit a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a modulation coding scheme (MCS) index, a resource associated with the HARQ feedback, a HARQ process number, a new data indicator (NDI), or any combination thereof; and transmit the set of transport blocks based at least in part on the received control message.

In some embodiment, the control message comprises a second field; the first field further indicates the MCS index or an MCS set; and the second field indicates the resource associated with the HARQ feedback, or a MCS sub-index within the MCS set, or any combination thereof.

In some embodiment, the control message further comprises a second field; and the first field further indicates the MCS index, or the HARQ process number and the NDI; and the second field indicates the resource associated with the HARQ feedback, the HARQ process number and the NDI or the MCS index.

In some embodiment, the first field includes multiple sub-fields, at least one of the multiple sub-fields indicates whether the HARQ feedback is enabled or disabled; the at least one sub-field is based at least in part on a quantity of transport blocks of the set of transport blocks.

In some embodiment, the resource associated with the HARQ feedback is based at least in part on the HARQ process number or a subframe number, or both.

In some embodiment, the processor is further configured to transmit a radio resource control (RRC) message indicating whether the HARQ feedback is enabled or disabled; the HARQ feedback enabled or disabled associated with the set of transport blocks indicated by the first field overrides the HARQ feedback enabled or disabled indicated by the RRC message.

In some embodiment, the processor is further configured to transmit a radio resource control (RRC) message indicating whether the HARQ feedback is enabled or disabled; the first field indicates whether HARQ feedback is enabled or disabled by indicating to override or to keep the HARQ feedback enabled or disabled indicated by the RRC message.

It means that to enable or disable the HARQ feedback based at least in part on the RRC message, the method comprises overriding an enabling or a disabling of the HARQ feedback, associated with the first field indicating whether the HARQ feedback is enabled or disabled for the set of transport blocks, based on the RRC message; or maintain the enabling or the disabling of the HARQ feedback associated with the first field indicating whether the HARQ feedback is enabled or disabled for the set of transport blocks.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a control message scheduling a set of transport blocks, wherein the set of transport blocks comprises one or more transport blocks, the control message comprising a first field indicating whether hybrid automatic repeat request (HARQ) feedback is enabled or disabled for the set of transport blocks, the first field further indicating a resource associated with the HARQ feedback; and
receive the set of transport blocks based at least in part on the received control message.

2. The UE of claim 1, wherein:
the control message comprises a second field; and
the second field indicates a modulating coding scheme (MCS) sub-index within an MCS set.

3. (canceled)

4. The UE of claim 1, wherein:
the first field includes multiple sub-fields;
at least one of the multiple sub-fields indicates whether the HARQ feedback is enabled or disabled; and
the at least one sub-field is based at least in part on a quantity of transport blocks of the set of transport blocks.

5. The UE of claim 1, wherein the resource associated with the HARQ feedback is based at least in part on a HARQ process number or a subframe number, or both.

6. The UE of claim 1, wherein the at least one processor is configured to cause the UE to:
receive a radio resource control (RRC) message indicating whether the HARQ feedback is enabled or disabled; and
the HARQ feedback enabled or disabled associated with the set of transport blocks indicated by the first field overrides the HARQ feedback enabled or disabled indicated by the RRC message.

7. The UE of claim 1, wherein the at least one processor is further configured to cause the UE to:
receive a radio resource control (RRC) message indicating whether the HARQ feedback is enabled or disabled; and
the first field indicates whether HARQ feedback is enabled or disabled by indicating to override or to keep the HARQ feedback enabled or disabled indicated by the RRC message.

8. A method performed by a user equipment (UE), the method comprising:
receiving a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a resource associated with the HARQ feedback; and
receiving the set of transport blocks based at least in part on the received control message.

9. A base station, comprising:
at least one memory; and
at least one processor coupled with the at least one memory and configured to cause the base station to:
transmit a control message scheduling a set of transport blocks, wherein the set of transport blocks comprise one or more transport blocks, the control message comprising a first field indicating whether hybrid automatic repeat request (HARQ) feedback is enabled or disabled for the set of transport blocks, the first field further indicating a resource associated with the HARQ feedback; and
transmit the set of transport blocks based at least in part on the transmitted control message.

10. The base station of claim 9, wherein,
the control message comprises a second field; and
the second field indicates a modulating coding scheme (MCS) sub-index within an MCS set.

11. (canceled)

12. The base station of claim 9, wherein:
the first field includes multiple sub-fields;
at least one of the multiple sub-fields indicates whether the HARQ feedback is enabled or disabled; and
the at least one sub-field is based at least in part on a quantity of transport blocks of the set of transport blocks.

13. The base station of claim 9, wherein the resource associated with the HARQ feedback is based at least in part on a HARQ process number or a subframe number, or both.

14. The base station of claim 9, wherein the at least one processor is configured to cause the base station UE to:
receive a radio resource control (RRC) message indicating whether the HARQ feedback is enabled or disabled; and
the HARQ feedback enabled or disabled associated with the set of transport blocks indicated by the first field overrides the HARQ feedback is enabled or disabled indicated by the RRC message.

15. The base station of claim 9, wherein the at least one processor is configured to cause the base station UE to:
receive a radio resource control (RRC) message indicating whether the HARQ feedback is enabled or disabled; and
the first field indicates whether HARQ feedback is enabled or disabled by indicating to override or to keep the HARQ feedback enabled or disabled indicated by the RRC message.

16. A processor for wireless communication, comprising:
at least one controller coupled with at least one memory and configured to cause the processor to:
receive a control message scheduling a set of transport blocks, wherein the set of transport blocks comprises one or more transport blocks, the control message comprising a first field indicating whether hybrid automatic repeat request (HARQ) feedback is enabled or disabled for the set of transport blocks, the first field further indicating a resource associated with the HARQ feedback; and
receive the set of transport blocks based at least in part on the received control message.

17. The processor of claim 16, wherein:
the control message comprises a second field; and
the second field indicates a modulating coding scheme (MCS) sub-index within an MCS set.

18. The processor of claim 16, wherein:
the first field includes multiple sub-fields;
at least one of the multiple sub-fields indicates whether the HARQ feedback is enabled or disabled; and
the at least one sub-field is based at least in part on a quantity of transport blocks of the set of transport blocks.

19. The processor of claim 16, wherein the resource associated with the HARQ feedback is based at least in part on a HARQ process number or a subframe number, or both.

20. The processor of claim 16, wherein the at least one controller is configured to cause the processor to:
receive a radio resource control (RRC) message indicating whether the HARQ feedback is enabled or disabled; and
the HARQ feedback enabled or disabled associated with the set of transport blocks indicated by the first field overrides the HARQ feedback enabled or disabled indicated by the RRC message.

21. The processor of claim 16, wherein the at least one controller is configured to cause the processor to:
receive a radio resource control (RRC) message indicating whether the HARQ feedback is enabled or disabled; and
the first field indicates whether HARQ feedback is enabled or disabled by indicating to override or to keep the HARQ feedback enabled or disabled indicated by the RRC message.

22. The method of claim 8, wherein:
the control message comprises a second field; and
the second field indicates the resource associated with the HARQ feedback.
